(19) United States
(12) Patent Application Publication
(10) Pub. No.: US 2009/0099718 A1
(43) Pub. Date: Apr. 16, 2009

(54) Device And Method For Determining the Center of Gravity Of A Vehicle

(75) Inventor: Christian Kobetz, Esslingen (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, Stuttgart (DE)

(21) Appl. No.: 11/792,377

(22) PCT Filed: Nov. 30, 2005
(86) PCT No.: PCT/EP05/12754

§ 371 Date: Apr. 25, 2008

(30) Foreign Application Priority Data
Dec. 7, 2004 (DE) 10 2004 058 791.4

(51) Int. Cl. B60G 17/016

(52) U.S. Cl. 701/29

(57) ABSTRACT

A device and a method for determining the height of the center of gravity of a vehicle, including a determining device which determines a pitching dynamics variable which represents the dynamic pitching behavior of the vehicle, and an evaluation unit to which the determined pitching dynamics variable for calculating a center of gravity height variable which represents the height of the center of gravity of the vehicle is fed. The determining device also determines a wheel force variable which represents a wheel force which occurs at at least one wheel of the vehicle, wherein the evaluation unit calculates the center of gravity height variable as a function of the determined pitching dynamics variable taking into account the determined wheel force variable.

### CROSS REFERENCE TO RELATED APPLICATIONS

This application is a continuation of PCT International Application No. PCT/EP2005/012754, filed Nov. 30, 2005, which claims priority under 35 U.S.C. § 119 to German Patent Application No. 10 2004 058 791.4 filed Dec. 7, 2004, the entire disclosures of which are herein expressly incorporated by reference.

### BACKGROUND AND SUMMARY OF THE INVENTION

The present invention relates to a device and a method for determining the height of the center of gravity of a vehicle, including a determining device which determines a pitching dynamics variable which represents the dynamic pitching behavior of the vehicle, and an evaluation unit to which the determined pitching dynamics variable for calculating a center of gravity height variable, which represents the height of the center of gravity of the vehicle, is fed.

International patent document WO 99/453446 discloses a device for determining mass-related variables for a vehicle in which a center of gravity height variable, which represents the height of the center of gravity of the vehicle, is determined on the basis of computationally acquired natural frequencies of a pitching movement of the vehicle body which is excited as a function of travel. Based on a pitching frequency spectrum acquired by a sensor, the amplitude spectrum of the pitching movement of the vehicle body is determined by applying a Fourier transformation, with the natural frequencies of the pitching movement resulting directly from the respective frequency of the increases in resonance which occur in the amplitude spectrum.

This method of natural frequency analysis is comparatively costly and gives rise to satisfactory results only if there is adequate excitation of pitching frequencies of the vehicle body. Such pitching frequencies are manifest to a comparatively small degree during normal travel of the vehicle. The center of gravity height variable and thus the height of the center of gravity of the vehicle can then be determined only to a limited degree.

An object of the present invention is to develop a device or a method of the type mentioned above which permits the height of the center of gravity of the vehicle to be determined easily and in a way which can be carried out precisely in the context of usual travel by the vehicle.

This and other objects and advantages are achieved by a device for determining the height of the center of gravity of a vehicle according to the present invention including, in addition to a determining device which determines a pitching dynamics variable which represents the dynamic pitching behavior of the vehicle, an evaluation unit which receives the determined pitching dynamics variable for calculating a center of gravity height variable, which represents the height of the center of gravity of the vehicle. According to exemplary embodiments of the present invention, the determining device also determines a wheel force variable which represents a wheel force which occurs at at least one wheel of the vehicle, wherein the evaluation unit calculates the center of gravity height variable as a function of the determined pitching dynamics variable taking into account the determined wheel force variable. The calculation of the center of gravity height variable can be carried out on the basis of easy-to-evaluate differential equations which include not only the determined pitching dynamics variable and the determined wheel force variable but also vehicle specific variables, such as the distance between the wheels of the vehicle in the longitudinal direction of the vehicle or the spring stiffness of wheel suspension devices of the vehicle.

Even when the driving style is moderate, comparatively high longitudinal dynamic forces occur at the vehicle body, at least for short time periods, in the course of the travel of the vehicle owing to deceleration and acceleration processes which are carried out by the driver or, if appropriate, also independently of the driver. These longitudinal dynamic forces lead to a pitching movement of the vehicle body which can be reliably sensed in the form of a corresponding pitching amplitude or change in the pitching amplitude over time. The same applies to the wheel force which occurs at the at least one wheel of the vehicle. The inventive logic combination of the determined pitching dynamics variable with the determined wheel force variable therefore permits the height of the center of gravity of the vehicle to be determined precisely in the context of usual travel of the travel.

According to exemplary embodiments of the present invention, the determining device advantageously determines the wheel force variable in conjunction with wheel assemblies, provided for influencing the longitudinal dynamics of the vehicle, being actuated by the driver and/or independently of the driver. The vehicle assemblies are typically wheel brake devices which are provided for braking wheels of the vehicle and/or a drive engine which interacts with drive wheels of the vehicle. The wheel brake devices or the drive engine are generally actuated by the driver by activating a brake control element or travel control element which is located in the vehicle, while actuation which is independent of the driver is generally initiated by a driver assistance system located in the vehicle.

The actuation of the wheel brake devices or of the drive engine brings about decelerating or accelerating forces at the respective wheels of the vehicle which themselves bring about comparatively high longitudinal dynamic forces at the vehicle body at least for short time periods even when there is a moderate driving style. These longitudinal dynamic forces bring about a pitching movement of the vehicle body which can be sensed in the form of a corresponding pitching amplitude or change in the pitching amplitude over time. The determined pitching dynamics variable can be considered in this case to be a response function of the determined wheel force variable. Between the determined wheel force variable and the determined pitching dynamics variable, there is a uniquely defined causal relationship which permits undesired extraneous influences, such as are caused, for example, by inclination of an underlying surface, to be effectively suppressed during the calculation of the center of gravity height variable.

Since such braking or deceleration processes occur abundantly in the course of usual travel by the vehicle, the calculated center of gravity height variable is continuously updated.

Furthermore, it is advantageous if the wheel force variable is determined by a wheel slip control device which is arranged in the vehicle, it being possible for the wheel slip control device to be a system for yaw rate control, for example, an electronic stability program (ESP) or the like. The wheel force variable is generally available internally so that it can also be used in such devices.

According to exemplary embodiments of the present invention, the wheel force variable represents a wheel longitudinal force which occurs as a front wheel and/or at a rear wheel of the vehicle. The precise sensing of such wheel longitudinal forces is possible with comparatively low technical expenditure and can be derived by evaluating control variables, for example, a predefined braking torque or a predefined drive torque, provided for actuating the wheel brake devices and/or the drive engine. The control variables are generally available at the CAN bus of the vehicle and can also be used to determine the wheel force variable.

The pitching movement of the vehicle body is most pronounced in the longitudinal direction of the vehicle due to the deceleration and acceleration forces acting on the vehicle in the course of the travel. For the purpose of easier sensing of the pitching dynamics variable, it is therefore advantageous if the pitching dynamics variable represents a pitching movement of the vehicle about a rotational axis which is oriented in the transverse direction of the vehicle.

The pitching dynamics variable can represent a pitching amplitude which is the maximum to occur in conjunction with the pitching movement of the vehicle. The maximum pitching amplitude which occurs clearly increases with the respective height of the center of gravity of the vehicle in this case, so that by determining the maximum pitching amplitude which occurs the center of gravity height variable can be calculated precisely. In vehicles with active stabilization of the vehicle body, the pitching dynamics variable or a corresponding variable is generally available so that it can also be used to compensate pitching movements of the vehicle body.

The mathematical relationship between the maximum pitching amplitude which occurs and the respectively associated center of gravity height variable can be stored in the form of a corresponding algorithm or an empirically determined characteristic curve in the evaluation unit.

The pitching movement of the vehicle can be sensed easily and reliably by a rotational speed sensor arranged in the vehicle whose measuring axis is oriented in the direction of the rotational axis of the pitching movement of the vehicle.

Additionally or alternatively, the pitching dynamics variable represents a wheel contact force occurring at a front wheel and/or at a rear wheel of the vehicle, in which case, given knowledge of the geometric distances between the wheels, the pitching movement of the vehicle body and thus the pitching dynamics variable can be clearly determined on the basis of the wheel contact forces which occur on a wheel specific basis.

In this case, it is appropriate to sense the wheel contact forces in order to determine the pitching dynamics variable via a force measuring device which is arranged in the vehicle, such as is used, for example, in conjunction with an active chassis of the vehicle. Such active chassis are available on a series manufacturing basis in some vehicles.

For many applications, it is sufficient to calculate the center of gravity height variable in accordance with predefined classification levels, as a result of which the computational capacity which is necessary to determine the height of the center of gravity and is ultimately made available by the evaluation unit can be reduced to a necessary minimum degree. The classification can be carried out in accordance with a linguistic state value such as “low”, “medium” or “high”.

The calculated center of gravity height variable may be advantageously used to adapt the triggering characteristic of a driver assistance system arranged in the vehicle and/or to parameterize a vehicle model on which the driver assistance system is based. It is possible for the driver assistance system to be a system for regulating the yaw rate of the vehicle, for example, an electronic stability program (ESP).

The electronic stability program serves here to prevent or reduce transverse dynamic instabilities of the vehicle by virtue of the fact that when a triggering condition which determines the triggering characteristic of the electronic stability program is met, vehicle-stabilizing measures are carried out in accordance with a vehicle model which serves as the basis for the electronic stability program. Since the instantaneous height of the center of gravity has a considerable influence on the transverse dynamic behavior of the vehicle, it is possible to ensure, through corresponding adaptation of the triggering characteristic of the electronic stability program, carried out as a function of the calculated center of gravity height variable, or through corresponding parameterization, performed by the calculated center of gravity height variable, of the vehicle model on which the electronic stability program is based, that reliable and situationally appropriate triggering or execution of the vehicle stabilizing countermeasures occur independently of the instantaneous height of the center of gravity of the vehicle.

Other objects, advantages and novel features of the present invention will become apparent from the following detailed description of the invention when considered in conjunction with the accompanying drawings.

### BRIEF DESCRIPTION OF THE DRAWINGS

FIG. 1 shows an exemplary embodiment of the device according to the invention for determining the height of the center of gravity of a vehicle, and

FIG. 2 shows an exemplary embodiment of the method according to the invention in the form of a flowchart.

### DETAILED DESCRIPTION OF THE DRAWINGS

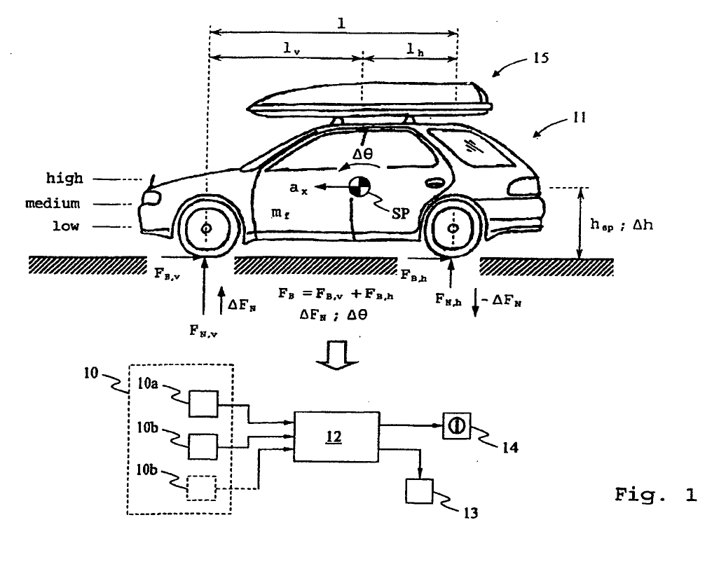

FIG. 1 shows an exemplary embodiment of the device according to the invention for determining the height of the center of gravity of a vehicle.

The device includes not only a determining device 10 which determines a pitching dynamics variable ΔF_{N} which represents the dynamic pitching behavior of the vehicle 11 but also an evaluation unit 12 to which the determined pitching dynamics variable ΔF_{N} for calculating a center of gravity height variable hₛₚ which represents the height of the center of gravity of the vehicle 11 is fed. The pitching dynamics variable ΔF_{N} represents here a pitching movement of the vehicle 11 about a rotational axis which is oriented in the transverse direction of the vehicle.

According to the invention, the determining device 10 also determines a wheel force variable F_{B} which represents a wheel force which occurs at at least one wheel of the vehicle 11, for example, a wheel longitudinal force F_{B,v} or F_{B,h} which occurs at a front wheel and/or at a rear wheel of the vehicle 11, wherein the evaluation unit 12 calculates the center of gravity height variable hₛₚ as a function of the determined pitching dynamics variable ΔF_{N} taking into account the determined wheel force variable F_{B}.

The pitching dynamics variable ΔF_{N} is intended in the present case to represent a wheel contact force F_{N,v}, F_{N,h} which occurs at a front wheel and/or at a rear wheel of the vehicle 11, in which case the pitching dynamics variable ΔF_{N} is defined according to a relationship of the form

ΔF_{N}=F_{N,v}−F_{N,h} (1.1)

The wheel contact forces F_{N,v}, F_{N,h} are sensed by a force measuring device 10a which is arranged in the vehicle 11 and which is a component of the determining device 10. The force measuring device 10a, which is an arrangement of acceleration sensors, force pickups or the like which are assigned to each wheel on an individual basis, is available, for example, in conjunction with an active chassis of the vehicle 11.

In addition, a differential equation of the form

$$Δ {F}_{N} = {m}_{f} \cdot {a}_{x} \cdot \frac{{h}_{sp}}{l} , \qquad ( 1.2 )$$

applies for the pitching dynamics variable ΔF_{N}, in which equation mf designates the mass of the vehicle 11, aₓ designates a longitudinal acceleration acting on the vehicle 11 and l designates the distance between the wheels of the vehicle 11 in the longitudinal direction of the vehicle. In order to derive equation (1.2), inter alia the distances lᵥ and lₕ of the front and rear wheels of the vehicle 11 are set in the longitudinal direction of the vehicle relative to the center of gravity SP of the vehicle 11. Then, the following applies

$$\begin{matrix}{m}_{f} \cdot {a}_{x} \cdot {h}_{sp} = {l}_{v} \cdot Δ {F}_{N , v} - {l}_{h} \cdot Δ {F}_{N , h} \\ = {l}_{v} \cdot Δ {F}_{N} + {l}_{h} \cdot Δ {F}_{N} \\ = ( {l}_{v} + {l}_{h} ) \cdot Δ {F}_{N} \\ = l \cdot Δ {F}_{N}\end{matrix} \qquad ( 1.3 )$$

From equation (1.2) there emerges for the center of gravity height variable hₛₚ, taking into account a force balance F_{B}=F_{B,v}+F_{B,h}=m_{f}·aₓ an easy-to-evaluate determination equation of the form

$${h}_{sp} = \frac{Δ {F}_{N}}{{F}_{B}} \cdot l . \qquad ( 1.4 )$$

The wheel force variable F_{B} is calculated by a wheel slip control device 10b which is arranged in the vehicle 11 and which is a yaw rate regulation system, for example, an electronic stability program (ESP) or the like. The wheel slip control device 10b is a component of the determining device 10, with the wheel force variable F_{B} being determined in accordance with a relationship of the form

$${F}_{B} = {C}_{p} \cdot \frac{{P}_{rad}}{R} - \frac{{M}_{KaHalb}}{R} + \frac{{J}_{rad}}{{R}^{2}} \cdot {v}_{rad} \qquad ( 1.5 )$$

in which Cₚ designates the braking torque transmission ratio, p_{rad} designates the wheel cylinder pressure, v_{rad} designates the measured wheel speed, J_{rad} designates the moment of the mass inertia of the wheel, R designates the wheel radius and M_{KaHalb} designates half of the Kardan shaft torque (cf. “Bosch, Kraftfahrtechnisches Taschenbuch [Automotive Manual]”, Robert Bosch GmbH, 23rd edition).

The determining device 10 determines the wheel force variable F_{B} in conjunction with vehicle assemblies, provided for influencing the longitudinal dynamics of the vehicle 11, being actuated by the driver and/or independently of the driver. The vehicle assemblies are typically wheel brake devices which are provided for braking wheels of the vehicle 11 and/or a drive motor which interacts with drive wheels of the vehicle 11. Actuation of the wheel brake devices or of the drive motor by the driver is carried out by activating a brake control element or travel control element located in the vehicle 11, while actuation which is independent of the driver is carried out by a driver assistance system 13 which is located in the vehicle 11 and is an electronic stability program (ESP).

The actuation of the wheel brake devices or the drive engine brings about decelerating or accelerating forces F_{B,v}, F_{B,h} at the respective wheels of the vehicle 11 which, even when the driving style is moderate, bring about comparatively high longitudinal dynamic forces at the vehicle body, at least for short time periods. These longitudinal dynamic forces bring about a pitching movement of the vehicle body which can be sensed in the form of a corresponding pitching amplitude or change in the pitching amplitude over time. The determined pitching dynamics variable ΔF_{N} can be considered in this case to be a response function of the determined wheel force variable F_{B}, and conversely the determined wheel force variable F_{B} therefore forms a test function for the determination of the pitching dynamics variable ΔF_{N}. Between the determined wheel force variable F_{B} and the determined pitching dynamics variable ΔF_{N} there is a uniquely defined causal relationship which makes it possible to suppress effectively undesired extraneous influences, such as are due to an inclination of the underlying surface, during the calculation of the center of gravity height variable hₛₚ.

According to the above explanations, the actuation of the wheel brake devices or of the drive engine forms a defined trigger for the determination of the wheel force variable F_{B} or of the pitching dynamics variable ΔF_{N} for the calculation of the center of gravity height variable hₛₚ. Since the wheel force variable F_{B} or the pitching dynamics variable ΔF_{N} is then calculated exclusively within the short time periods of the actuation of the wheel brake devices or of the drive engine, chronologically prolonged changes in the wheel force variable F_{B} or of the pitching dynamics variable ΔF_{N}, due to inclination of the underlying surface, for example, only result in negligible effects on the center of gravity height variable hₛₚ which is calculated on the basis of these variables.

Additionally or alternatively to the use of the wheel slip control device 10b, the wheel force variable F_{B} is derived by evaluating control variables (e.g., a predefined braking torque or a predefined drive torque), which are provided for actuating the wheel brake devices and/or the drive motor. The control variables are available at a CAN bus which is located in the vehicle 11.

According to an alternative embodiment of the device according to the invention, instead of the pitching dynamics variable ΔF_{N}, a pitching dynamics variable Δθ which represents a pitching amplitude which is the maximum to occur in conjunction with the pitching movement of the vehicle 11 is determined in conjunction with the actuation of the wheel brake devices or of the drive engine,

$$Δ θ = {\int }_{t 0}^{t 1} \frac{\partial θ}{\partial t} \cdot d t . \qquad ( 2.1 )$$

Here, tₛₜₐᵣₜ designates the time of actuation of the wheel brake devices or of the drive engine and t_{end} designates that time at which the pitching amplitude assumes its maximum absolute value (reversal point of the pitching movement),

$$\frac{\partial θ}{\partial t} d t {\vert}_{max} \qquad ( 2.2 )$$

The integration of the equation (2.1) under the peripheral condition (2.2) is carried out by the evaluation unit 12 on the basis of a rotational speed signal which is made available by a rotational speed sensor 10c whose measuring axis is oriented in the direction of the rotational axis of the pitching movement of the vehicle 11, the rotational speed signal representing the rotational speed of the pitching movement of the vehicle body. The rotational speed sensor 10c is a component of the determining device 10.

Instead of the rotational speed sensor 10c, an arrangement of linear acceleration sensors which are oriented in the longitudinal and vertical directions of the vehicle may be provided and the evaluation unit 12 determines the pitching dynamics variable Δθ from the signals of the sensors.

In vehicles 11 with an active stabilization of the vehicle body, the pitching dynamics variable Δθ or a variable which corresponds thereto is generally available so that it can also be used to compensate pitching movements of the vehicle body.

Taking the determined wheel force variable F_{B} and the absolute value of the determined pitching dynamics variable Δθ as a basis, the evaluation unit 12 calculates a center of gravity height variable Δh which represents a change in the height of the center of gravity of the vehicle 11 on the basis of a cargo 15 and the like. To be more precise, the center of gravity height variable Δh represents a distance between the pitching pole of the vehicle body and the height SP of the center of gravity of the vehicle 11. In this context a differential equation is used with the form

J_{y}·θ+D_{ω}·θ+C_{ω}·θ=m·aₓ·Δh. (2.3)

in which J_{y} designates the moment of mass inertia of the vehicle 11 in the transverse direction of the vehicle, D_{ω} designates the damping constant of the wheel suspension device of the vehicle 11 and C_{ω} designates the spring stiffness of the wheel suspension devices of the vehicle 11. Since only the limiting state of the pitching movement of the vehicle body which is caused by the actuation of the wheel brake devices or of the drive engine is considered within the sense of equation (2.2), this being in fact the maximum absolute value to occur for the pitching amplitude of the pitching movement, the derivatives \dot{θ}, \ddot{θ} over time of the variable θ=θ(t) which represents the value of the pitching dynamics variable Δθ at the time t disappear. As a result, equation (2.3) can be simplified to

C_{ω}·|Δθ|=m·aₓ·Δh, (2.4)

which taking into account the force balance F_{B}=m·aₓ for the center of gravity height variable Δh yields an easy-to-evaluate determination equation of the form

$$Δ h = \frac{{C}_{ω}}{{F}_{B}} \cdot \vert Δ θ \vert , \qquad ( 2.5 )$$

Given a known height of the center of gravity of the vehicle 11 in the unladen state, it is possible to determine directly the absolute height of the center of gravity of the vehicle 11 from the center of gravity height variable Δh.

The mathematical relationship according to the two alternative determination equations (1.4) and (2.5) is stored in the form of a corresponding algorithm or an empirically determined characteristic curve in the evaluation unit 12.

For many applications it is sufficient to determine the height of the center of gravity in accordance with predefined classification levels. According to one alternative embodiment of the device according to the invention, the evaluation device 12 therefore carries out a classification of the height of the center of gravity of the vehicle 11 on the basis of the calculated center of gravity height variable hₛₚ or Δh in accordance with the linguistic state values “low”, “medium” or “high”.

The calculated center of gravity height variable hₛₚ or Δh is used, inter alia, to adapt the triggering characteristic of the driver assistance system 13 and/or to parameterize a vehicle model on which the driver assistance system 13 is based, the driver assistance system 13 being a system, (e.g., an electronic stability program (ESP)) for regulating the yaw rate of the vehicle 11.

The electronic stability program serves here to prevent or reduce transverse dynamic instabilities of the vehicle 11 by virtue of the fact that when a triggering condition which determines the triggering characteristic of the electronic stability program is met, vehicle-stabilizing measures are carried out in accordance with a vehicle model which serves as the basis for the electronic stability program. Since raising the center of gravity SP has considerable effects on the transverse dynamic behavior of the vehicle 11, the triggering characteristic of the electronic stability program is adapted as a function of the calculated center of gravity height variable hₛₚ or Δh, or the vehicle model which serves as a basis for the electronic stability program is parameterized by means of the calculated center of gravity height variable hₛₚ or Δh in such a way that reliable and situationally appropriate triggering or execution of the vehicle-stabilizing measures is ensured independently of the instantaneous height of the center of gravity of the vehicle 11.

In order to make the driver aware of the presence of a raised center of gravity SP, a signal transmitter unit 14 which is provided for outputting a visual and/or audible driver indication is actuated as a function of the center of gravity height variable hₛₚ or Δh, the driver information being output if a decisive increase in the height of the center of gravity is identified, that is to say if, for example, the classified height of the center of gravity has the linguistic state value “medium” or “high”.

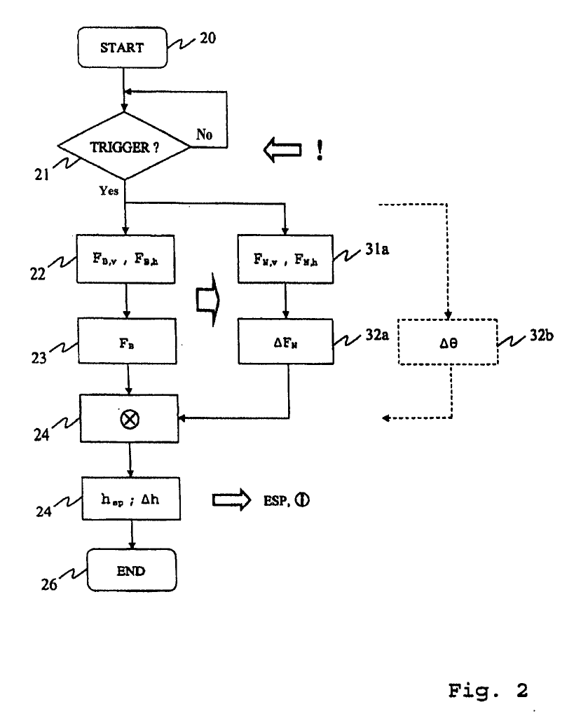

FIG. 2 shows an exemplary embodiment of the method according to the invention in the form of a flowchart.

The method is started in an initialization step 20, after which, in a first main step 21, it is checked whether the wheel brake devices or the drive engine of the vehicle 11 are actuated.

If it is determined in the first main step 21 that the wheel brake devices or the drive engine of the vehicle 11 are not actuated, the method quickly returns to the beginning. Otherwise, in a second main step 22 the wheel longitudinal force F_{B,v}, F_{B,h} which occurs at the front wheel and/or at the rear wheel of the vehicle 11 is sensed, the wheel force variable F_{B} being determined in a third main step 23 on the basis of the sensed wheel longitudinal force F_{B,v}, F_{B,h}.

In a first secondary step 31a, the wheel contact forces F_{N,v}, F_{N,h} are sensed in parallel with the execution of the two main steps 22 and 23, with the pitching dynamics variable ΔF_{N} being determined in a second secondary step 32a on the basis of the sensed wheel contact forces F_{N,v}, F_{N,h}.

The wheel force variable F_{B} which is determined in the third main step 23 and the pitching dynamics variable ΔF_{N} which is determined in the second secondary step 32a are logically combined in a common fourth main step 24 in accordance with equation (1.4), with the center of gravity height variable hₛₚ which is calculated in this way being made available in a subsequent fifth main step 25.

The method is then terminated in a concluding step 26.

According to one alternative embodiment of the method according to the invention, instead of the two secondary steps 31a and 31b, an individual secondary step 32b is provided in which the pitching dynamics variable Δθ is determined on the basis of the equation (2.1) under the peripheral condition (2.2).

The wheel force variable F_{B} which is determined in the third main step 23 and the pitching dynamics variable Δθ which is determined in the secondary step 32b are then logically combined in the fourth main step 24 in accordance with equation (2.5), with the center of gravity height variable Δh which is calculated in this way being made available in the subsequent fifth main step 25.

The center of gravity height variable hₛₚ or Δh calculated in this way is used, inter alia, to adapt the triggering characteristic of the driver assistance system 13 and/or to parameterize the vehicle model on which the driver assistance system 13 is based, the driver assistance system 13 being a system (e.g., an electronic stability program (ESP)) for regulating the yaw rate of the vehicle 11. In addition, the signal transmitter unit 14 which is provided for outputting the visual and/or audible driver indication is actuated as a function of the center of gravity height variable hₛₚ or Δh.

The method according to the invention is implemented by means of software in the form of a corresponding source code in the evaluation unit 12.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-12. (canceled)

13. A device for determining the height of a center of gravity of a vehicle, said device comprising:
a determining device which determines a pitching dynamics variable of the vehicle and a wheel force variable of a wheel of the vehicle; and
an evaluation unit which calculates a center of gravity height variable as a function of the determined pitching dynamics variable and the determined wheel force variable;
wherein the wheel force variable represents a wheel longitudinal force at one or both of at least one front wheel and at least one rear wheel of the vehicle.

14. The device as claimed in claim 13, wherein the determining device determines the wheel force variable in conjunction with vehicle assemblies that are provided for influencing the longitudinal dynamics of the vehicle and are actuated by the driver or independently of the driver.

15. The device as claimed in claim 13, wherein the wheel force for determining the wheel force variable is calculated by a wheel slip control device arranged in the vehicle.

16. The device as claimed in claim 13, wherein the pitching dynamics variable represents a pitching movement of the vehicle about a rotational axis which is oriented in the transverse direction of the vehicle.

17. The device as claimed in claim 16, wherein the pitching dynamics variable represents a pitching amplitude which is the maximum to occur in conjunction with the pitching movement of the vehicle.

18. The device as claimed in claim 13, wherein a pitching movement of the vehicle is sensed in order to determine the pitching dynamics variable using a rotational speed sensor which is arranged in the vehicle.

19. The device as claimed in claim 13, wherein the pitching dynamics variable represents a wheel contact force which occurs at one or both of the at least one front wheel and the at least one rear wheel of the vehicle.

20. The device as claimed in claim 19, wherein the wheel contact force is sensed in order to determine the pitching dynamics variable using a force measuring device which is arranged in the vehicle.

21. The device as claimed in claim 13, wherein the center of gravity height variable is calculated in accordance with predefined classification levels.

22. The device as claimed in claim 13, wherein the center of gravity height variable is used for at least one of adapting the triggering characteristic of a driver assistance system arranged in the vehicle and parameterizing a vehicle model on which the driver assistance system is based, the driver assistance system being a system for regulating a yaw rate of the vehicle.

23. A method for determining the height of a center of gravity of a vehicle, said method comprising:
determining a pitching dynamics variable of the vehicle;
calculating a center of gravity height variable of the vehicle as a function of the determined pitching dynamics variable; and
determining a wheel force variable of a wheel of the vehicle;
wherein the wheel force variable represents a wheel longitudinal force which occurs at one or both of at least one front wheel and at least one rear wheel of the vehicle.
